(19) United States
(12) Patent Application Publication
(10) Pub. No.: US 2010/0127973 A1
(43) Pub. Date: May 27, 2010

(54) Display Systems

(76) Inventor: Neil Turton, Cambridgeshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/516,744

(22) PCT Filed: Nov. 29, 2006
(86) PCT No.: PCT/GB2006/050420

§ 371 Date: Jan. 22, 2010

(51) Int. Cl. G09G 5/08

(52) U.S. Cl. 345/157

(57) ABSTRACT

This invention relates to methods, apparatus and computer program code for television and other display systems and, in particular, to improved methods of navigating around a screen display of such a system. A method of navigating a marker between regions of a screen display using a set of direction keys each defining one of four substantially mutually perpendicular directions, the method comprising: inputting a movement request defined by a said movement direction key from a current region indicated by said marker; identifying when said movement request comprises a request for movement in a direction substantially perpendicular to a previous movement request; performing a target search responsive to said identifying of said perpendicular movement request, to locate a target region for said marker; moving said marker to said target region.

This invention relates to methods, apparatus and computer program code for television and other display systems and, in particular, to improved methods of navigating around a screen display of such a system.

With a TV based device it is rare that a user has access to a pointing device such as a mouse. In such an environment, it is usually necessary for the user to be able to select items on the screen using a device like a remote control which has a small keyboard.

This navigation method allows the items on the screen to be selected using four “arrow” keys. When the user presses the right arrow, it is expected that the next item to the right becomes selected. This poses problems since there may be more than one item to the right which could be selected. In some situations this ambiguity may lead to items which cannot be selected.

An example of such a situation is where some number of items are organised along the edges of a diamond with another item in the middle. Depending upon the exact display configuration, the sensor or highlight can often navigate to the nearest neighbours of the current item and so follow the edges of the diamond without providing any way to reach the item in the middle.

Although the problem may give the appearance of being relatively straightforward, in practice it is non-trivial to determine a procedure which works in a reasonably intuitive manner for what can sometimes be complex screen displays.

Background art may be found in the following publications: US 2003/0014401, GB2370740, US 2004/0041837.

According to the invention there is therefore provided a method of navigating a marker between regions of a screen display using a set of direction keys each defining one of four substantially mutually perpendicular directions, the method comprising: inputting a movement request defined by a said movement direction key from a current region indicated by said marker; identifying when said movement request comprises a request for movement in a direction substantially perpendicular to a previous movement request; performing a target search responsive to said identifying of said perpendicular movement request, to locate a target region for said marker; moving said marker to said target region.

Preferably the target search comprises identifying a region which would be hit or contacted by a wavefront propagating from the current region in the perpendicular movement direction (to the last previous movement direction). Preferably the wavefront includes a line substantially perpendicular to the movement direction; this may be defined by a portion of a bounding box of the current region (although it need not exactly correspond to a boundary of the bounding box). Preferably this line is substantially parallel to an edge of the boundary box which is perpendicular to the perpendicular movement direction, and preferably this line is propagated from a starting position approximately corresponding with an edge of the bounding box furthest along the perpendicular movement direction. Preferably this line is a straight line. Thus, some preferred embodiments, the wavefront comprises this line and a trailing edge at one or both ends of the line (the ends of the line preferably correspond with edges of the bounding box at the starting position of the wavefront).

A previous movement direction may be defined as being the direction of the previous movement request which moves the marker from a previous region to the current region. Preferably the wavefront then extends in this previous movement direction substantially from a first boundary of the previous region which would be reached moving away from the current region in a reverse direction to the previous movement direction to a second boundary of the current region which would be reached moving in the previous movement direction. Thus, effectively, when a user navigates from region A to region B in one direction and then navigates from B in a perpendicular direction, the perpendicular direction step is confined to be between the side of a nearest B and the side of B furthest from A, this allowing the navigation to proceed to an item which is not necessarily one of the nearest neighbours of B. Thus, in effect, the current region is extended in the previous movement direction back to the previous region before beginning the search from the current region to locate the target region. Thus in embodiments the search is substantially confined to a region of the screen display having boundaries defined by a side of a previous region nearest the current region (in a previous movement direction) and a side of the current region furthest from the previous region.

In some preferred embodiments the screen display comprises a television screen display and the direction keys comprise up, down, left and right keys of a remote control for the television. The method may be implemented, for example, on a set top box (STB) or on a computer system within the television.

In some alternative embodiments the screen display comprises a display of a portable electronic device such as a mobile phone or portable audio and/or video player. In some preferred embodiments the method is implemented as part of a mark up language browser such as an HTML or XML browser.

In another aspect the invention provides a computer system for providing a screen display having a plurality of regions, and for enabling a user to navigate a marker between said regions using a set of direction keys each defining one of four mutually perpendicular directions, the system comprising: data memory for storing data for said screen display; an input for inputting a movement request defined by a said movement direction key from a current region indicated by said marker; an output for outputting said stored data for providing said screen display; program memory storing processor control code; and a processor coupled to said input, to said output, to said data memory and to said program memory, to load and implement said control code, said control code comprising code for controlling the processor to: identify when said movement request comprises a request for movement in a direction substantially perpendicular to a previous movement request; perform a target search responsive to said identifying of said perpendicular movement request to locate a target region for said marker; and move said marker to said target region.

According to a further aspect of the present invention there is provided a method of navigating a market between regions of a screen display using a set of direction keys each defining one of four substantially mutually perpendicular directions, the method comprising: inputting a movement request defined by a said movement direction key from a current region indicated by said marker; performing a target search responsive to said movement request to locate a target region for said marker; and moving said market to said target region.

According to a corresponding aspect the invention provides a computer system for providing a screen display having a plurality of regions, and for enabling a user to navigate a marker between said regions using a set of direction keys each defining one of four mutually perpendicular directions, the systems comprising: data memory for storing data for said screen display; an input for inputting a movement request defined by a said movement direction key from a current region indicated by said marker; an output for outputting said stored data for providing said screen display; program memory storing processor control code; and a processor coupled to said input, to said output, to said data memory and to said program memory, to load and implement said control code, said control code comprising code for controlling the processor to: perform a target search responsive to said movement request to locate a target region for said marker; and move said marker to said target region.

The invention further provides processor control code to implement the above-described systems and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

These and other aspects of the invention will now be further described, by way of example only, with reference to the accompanying figures in which:

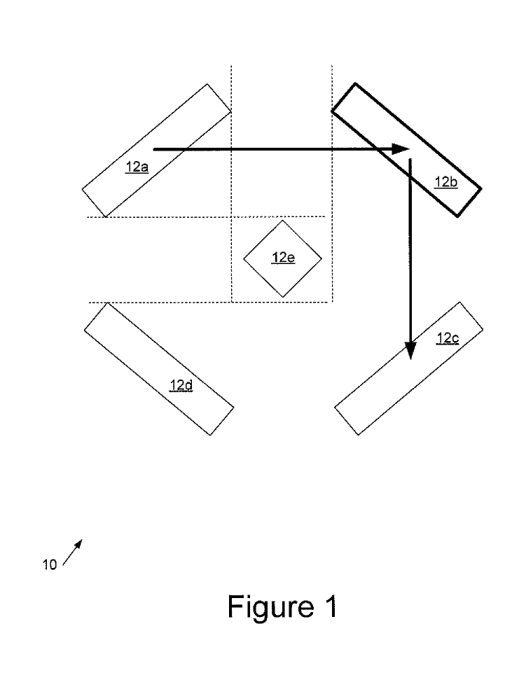

FIG. 1 shows a portion of a screen display illustrating keyboard-based navigation;

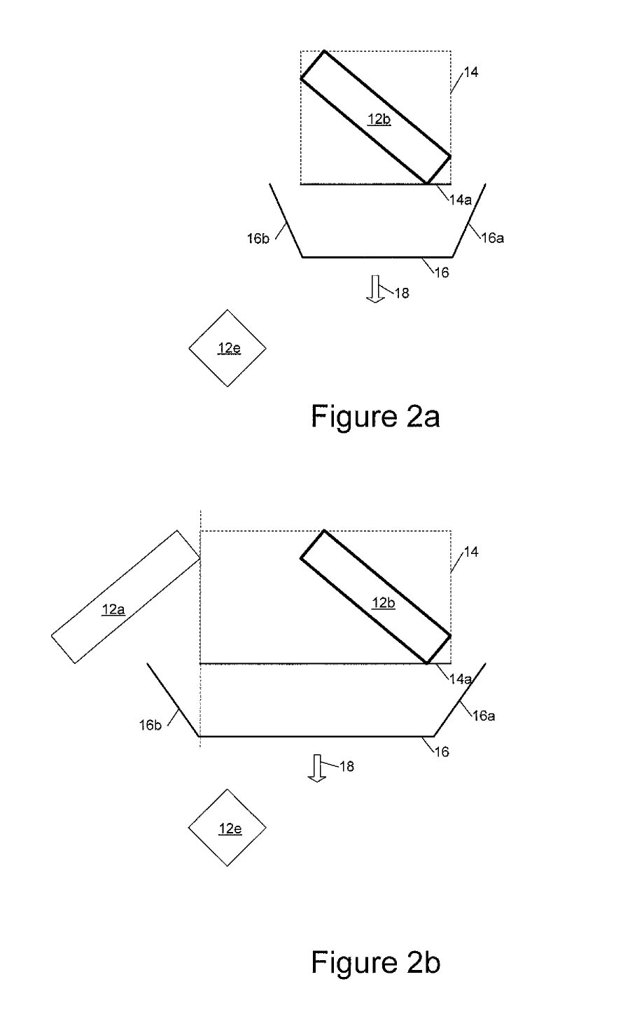

FIGS. 2a and 2b show first and second examples of a target search system according to embodiments of the present invention;

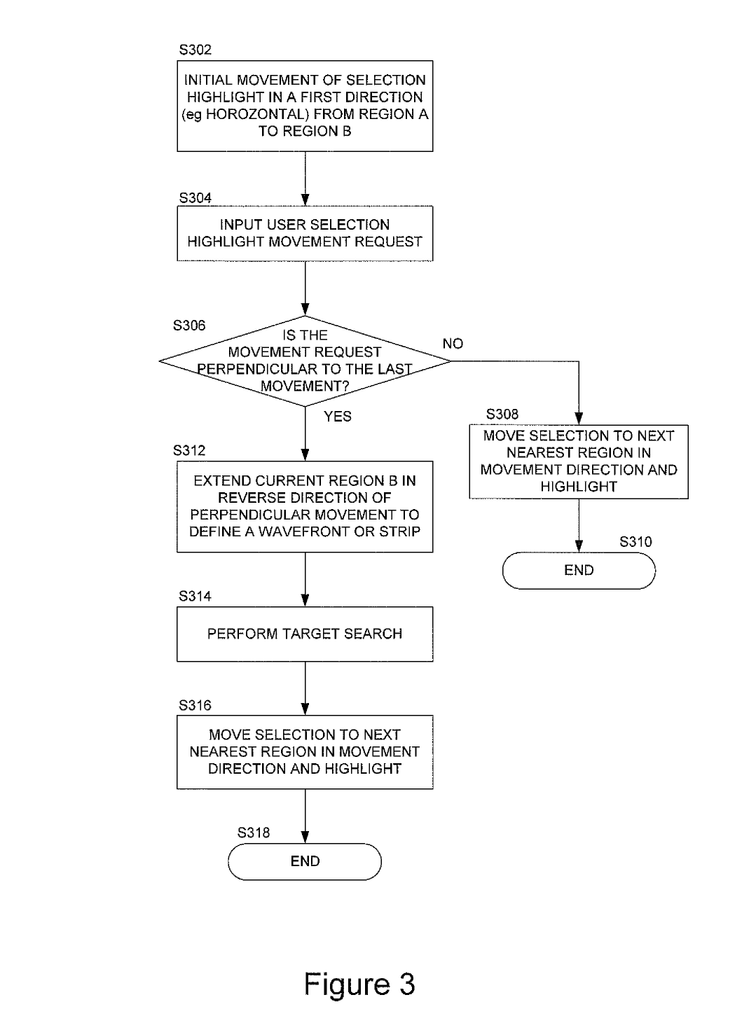

FIG. 3 shows a flow diagram of a target search extension procedure embodying an aspect of the present invention;

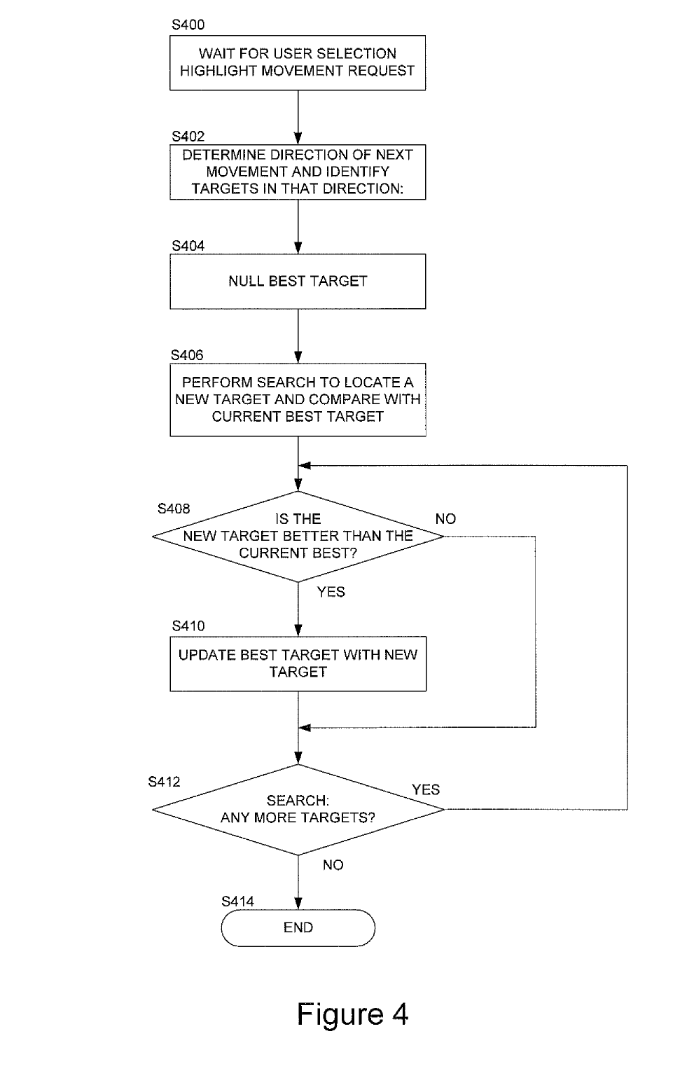

FIG. 4 shows a target search procedure embodying an aspect of the present invention; and

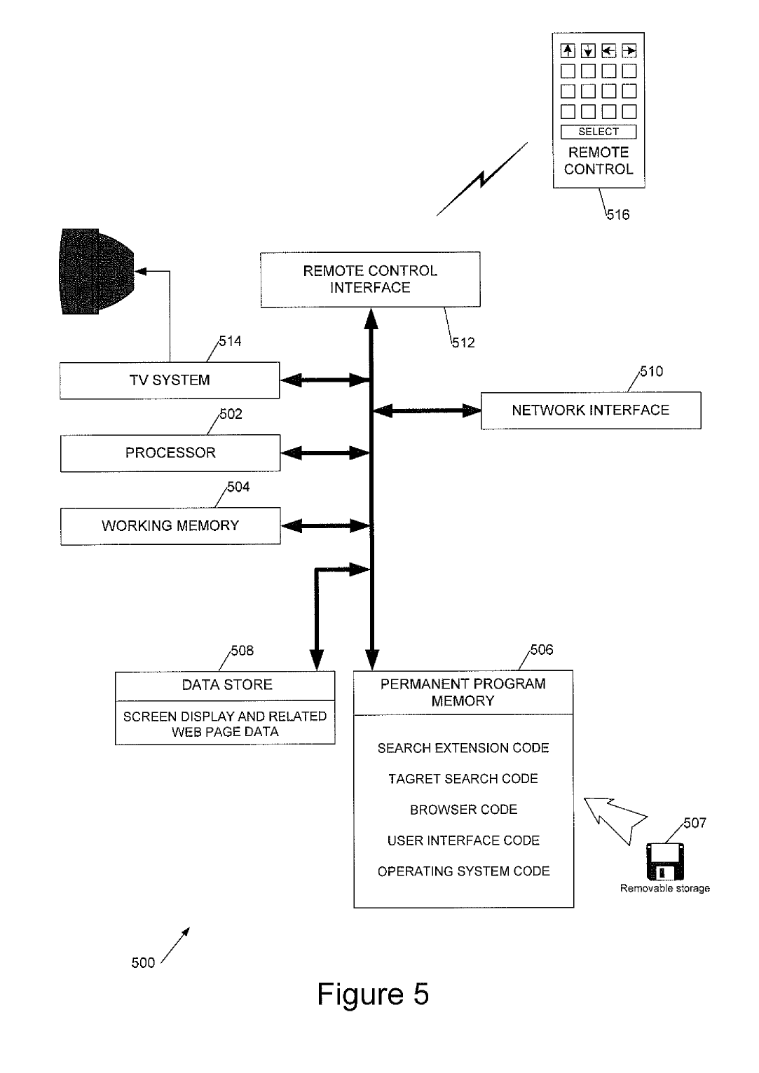

FIG. 5 shows a block diagram of a system embodying an aspect of the present invention.

Referring to FIG. 1, this shows a simplified example of a portion of a screen display 10 including a plurality of user selectable regions 12a-e. In some preferred embodiments of the invention the screen display 10 comprises a display on a television or other similar multimedia home entertainment device screen with which a user interacts via a remote control device including a plurality of direction keys for moving a cursor or highlight amongst the regions. In the example of FIG. 1, region 12b is shown highlighted, the highlight previously having been moved from region 12a. Typically a remote control device has up, down, left and right cursor/highlight motion keys to enable a user to navigate amongst the user-selectable regions 12. FIG. 1 illustrates a problem with simple navigation systems in which the next item in the direction of user-selected motion is identified and highlighted, since it can be seen that if only four perpendicular movement direction keys are available to the user then only regions 12a-d can be selected and region 12e is never selected. In practice, screen displays are typically much more complex than that illustrated in FIG. 1, but nonetheless similar problems arise.

FIG. 2a illustrates a portion of the screen display of FIG. 1, showing the concept behind an improved target search system. A bounding box 14, in this example a rectangle, is drawn around the current highlighted region and one edge 14a of this boundary box, in particular the edge furthest along the new common desired direction of movement of the highlight, is used as a fiducial line. This fiducial line is used to generate a wavefront 16, preferably with a pair of trailing edges, which is propagated from fiducial line 14a in the new desired direction of motion, shown in FIG. 2a by arrow 18. As can be seen from FIG. 2a, this improves the likelihood that a region such as region 12e will be touched or intersected by the wavefront 16 prior to region 12c. However as drawn in FIG. 2a the trailing edge 16b of wavefront 16 would still just miss region 12e.

FIG. 2b, in which like elements to those of FIG. 2a are indicated by like reference numerals, shows a modification of the concept of FIG. 2a in which the bounding box 14 is extended in the reverse direction of the motion which arrived at region 12b, until the previous region 12a is reached. This extends the fiducial line 14a and wavefront 16 thus ensuring that region 12e is intersected by the wavefront and selectable by the user.

Referring now to FIG. 3, this shows a flow diagram for the extension procedure of FIG. 2b.

At step S302 there is initial movement of the selection highlight in a first direction, for example horizontal, from region a (for example region 12a) to region b (for example region 12b). Then, at S304, a selection highlight movement request from the user is inputted, and at step S306 the procedure checks whether the movement request is perpendicular to the last movement (in one embodiment a vector comprising current and previous highlighted positions is maintained). If the movement request is not perpendicular then, at step S308, the selection is moved to the next nearest region in the movement direction and this region is highlighted; preferably the target search procedure of FIG. 4 (described below) is employed. The procedure then ends at step S310. If the current movement request is perpendicular to the previous movement then, at step S312, the current region b, or more particularly the bounding box, is extended as shown in FIG. 2b to define a stripe in the direction of perpendicular movement along which wavefront 16 will propagate. Preferably the stripe is bounded by the edge or point of the current region furthest from the previous region and the edge or point of the previous region closest to the current region, in the example of FIG. 2b the left edge of the stripe being the right edge of region 12a and the right edge of the stripe being the right edge of region 12b. The procedure then performs a target search (S314) as described below and then, at step 316, moves the selection highlight to the next nearest region in the movement direction as defined by the movement procedure, and ends (S318).

Referring now to FIG. 4, this shows an embodiment of the target search procedure. At step S400 the procedure waits for a movement request (or other invocation, for example from FIG. 3), and then at step S402 determines the direction of next movement and implements a procedure to identify targets and find the best target in that direction.

Thus at step S404 the procedure nulls a “best target” variable and then at step S406 performs a search to locate a new target by propagating a boundary or wavefront from the fiducial line on the origin region or bounding box, as shown in FIG. 2b. The new target is compared with the current best target (S408) and if the new target is better than the current best then the current best is updated (S410) otherwise the procedure searches for more targets (S412) and if any exist then continues to check each with the current best until there are no more when the procedure ends at S414. In one embodiment the “best” target is determined by a figure of merit, in particular the distance the wavefront 16 would need to move before the target is hit (in effect the target which would be hit first). To determine this each potential target may be checked in turn.

FIG. 5 shows a block diagram of a system 500 configured to implement the above described methods. This comprises a processor 502 coupled to working memory 504, and non-volatile memory 506 storing search extension code, target search code, browser code, user interface code and operating system code for processor 502 to load and implement as described above. This code may be provided on a removable storage medium, by way of example illustrated by disk 507 and/or downloaded from a remote source. Thus as illustrated system 500 includes a network interface 510 for a cable, terrestrial, satellite or other feed, and a data store 508 for storing screen display and related web page data such as electronic program guide data, with which aspects of the invention may be employed. System 500 also includes a TV system 514 although in alternative arrangements the system 500 and in particular processor 502 and the program and data memory may be implemented within the TV system with additional stored code for one or more existing processors of the system. A remote control interface 512 for receiving user commands from a remote control 516, including the above mentioned cursor/highlight movement commands, is also provided.

No doubt many other effective alternatives will occur to the skilled person. For example applications of embodiments of the invention are not limited to television systems and/or systems with a remote control but include, for example, portable music and/or video players. Again, it will be appreciated, the search for the best target may be performed by implementing a procedure to remove the wavefront 16 until a target is hit, or by checking for each potential target, the distance the wavefront would have to move in order for the target to be hit (if hit at all).

It will be understood that the invention is not limited to the described embodiments and encompasses modifications apparent to those skilled in the art lying within the spirit and scope of the claims appended hereto.

1-16. (canceled)

17. A method of navigating a marker between regions of a screen display using a set of direction keys each defining one of four substantially mutually perpendicular directions, the method comprising:
inputting a movement request defined by a said movement direction key from a current region indicated by said marker;
identifying when said movement request comprises a request for movement in a direction substantially perpendicular to a previous movement request;
performing a target search responsive to said identifying of said perpendicular movement request, to locate a target region for said marker;
moving said marker to said target region.

18. A method as claimed in claim 17 wherein said performing of said target search comprises identifying a region which would be hit by a wavefront propagating from said current region in said perpendicular movement direction.

19. A method as claimed in claim 18 wherein said wavefront includes a line substantially perpendicular to said perpendicular movement direction.

20. A method as claimed in claim 19 wherein said line is defined by a portion of a bounding box of said current region.

21. A method as claimed in claim 20 wherein said previous movement request moved said marker from a previous region to said current region in a previous movement direction, and wherein said wavefront extends in said previous movement direction substantially from a first boundary of said previous region which would be reached moving from said current region in a reverse direction to said previous movement direction to a second boundary of said current region which would be reached moving in said previous movement direction.

22. A method as claimed in claim 19 wherein said wavefront comprises said line and a pair of trailing edges at each end of said line.

23. A method as claimed in claim 17 wherein said previous movement request moved said marker from a previous region to said current region, and wherein said search comprises a search of a region of said screen display having boundaries defined by a side of a previous region nearest said current region and a side of said current region furthest from said previous region.

24. A method as claimed in claim 17 wherein said screen display comprises a tv screen display and wherein said direction keys comprise up, down, left and right keys of a remote control for the tv.

25. A method as claimed in claim 17 wherein said screen display comprises a screen display of a portable electronic device, and wherein said direction keys comprise up, down, left and right keys of said device.

26. A carrier carrying processor control code to, when running, implement the method of claim 17.

27. A method of navigating a market between regions of a screen display using a set of direction keys each defining one of four substantially mutually perpendicular directions, the method comprising:
inputting a movement request defined by a said movement direction key from a current region indicated by said marker;
performing a target search responsive to said movement request to locate a target region for said marker; and
moving said market to said target region.

28. A method as claimed in claim 27 wherein said performing of said target search comprises identifying a region which would be hit by a wavefront propagating from said current region in said perpendicular movement direction.

29. A method as claimed in claim 27 wherein said screen display comprises a tv screen display and wherein said direction keys comprise up, down, left and right keys of a remote control for the tv.

30. A method as claimed in claim 27 wherein said screen display comprises a screen display of a portable electronic device, and wherein said direction keys comprise up, down, left and right keys of said device.

31. A carrier carrying processor control code to, when running, implement the method of claim 27.

32. A computer system for providing a screen display having a plurality of regions, and for enabling a user to navigate a marker between said regions using a set of direction keys each defining one of four mutually perpendicular directions, the system comprising:
data memory for storing data for said screen display;
an input for inputting a movement request defined by a said movement direction key from a current region indicated by said marker;
an output for outputting said stored data for providing said screen display;
program memory storing processor control code; and
a processor coupled to said input, to said output, to said data memory and to said program memory, to load and implement said control code, said control code comprising code for controlling the processor to:
identify when said movement request comprises a request for movement in a direction substantially perpendicular to a previous movement request;
perform a target search responsive to said identifying of said perpendicular movement request to locate a target region for said marker; and
move said marker to said target region.

33. A computer system for providing a screen display having a plurality of regions, and for enabling a user to navigate a marker between said regions using a set of direction keys each defining one of four mutually perpendicular directions, the systems comprising:
data memory for storing data for said screen display;
an input for inputting a movement request defined by a said movement direction key from a current region indicated by said marker;
an output for outputting said stored data for providing said screen display;
program memory storing processor control code; and
a processor coupled to said input, to said output, to said data memory and to said program memory, to load and implement said control code, said control code comprising code for controlling the processor to:
perform a target search responsive to said movement request to locate a target region for said marker; and
move said marker to said target region.

34. A television system including the computer system of claim 32 and a remote control bearing said set of direction keys to provide said movement request.

35. A television system including the computer system of claim 33 and a remote control bearing said set of direction keys to provide said movement request.

36. A system as claimed in claim 32 wherein said processor control code comprises part of a markup language browser.

37. A system as claimed in claim 33 wherein said processor control code comprises part of a markup language browser.
